(19) United States
(12) Patent Application Publication
(10) Pub. No.: US 2017/0022350 A1
(43) Pub. Date: Jan. 26, 2017

(54) VISIBLE LIGHT-CURING OF PHOTOCURABLE COMPOSITIONS IN AMBIENT ATMOSPHERE

(71) Applicant: BASF SE, Ludwigshafen (DE)

(72) Inventors: Stefan FUELDNER, Trostberg (DE); Iris LOESCHER, St. Pantaleon (AT)

(73) Assignee: BASF SE, Ludwigshafen (DE)

(21) Appl. No.: 15/301,880

(22) PCT Filed: Mar. 25, 2015
(86) PCT No.: PCT/EP2015/056436

§ 371 Date: Oct. 4, 2016

(30) Foreign Application Priority Data
Apr. 7, 2014 (EP) 14163698.5

(51) Int. Cl. C08K 5/07; C08K 5/1545; B05D 3/06; C09J 5/00; C09D 135/02; C09J 135/02; C09D 133/14; C09J 133/14

(52) U.S. Cl. CPC C08K 5/07; C09D 133/14; C08K 5/1545; C09J 133/14; C09J 5/00; C09D 135/02; C09J 135/02; B05D 3/06; C09J 2205/102; C09J 2205/31; C09J 2433/00

(57) ABSTRACT

A photocurable composition is curable by exposure to visible light, and comprises a free-radical polymerizable compound and a photoinitiating system, the photoinitiating system comprising a) a dye which is excitable by visible light and has a triplet energy form 150 kJ/mol to 250 kJ/mol, such as Eosin Yellow and Fluorescein, and b) an α-halogen carbonyl compound. Preferably, the composition comprises a compound with a C—H-acidic hydrogen atom adjacent to at least one carbonyl group. The composition is cured by visible light in an oxygen-containing atmosphere and results in tack-free, colorless coatings.

The present invention relates to photocurable compositions that are curable by exposure to visible light, and to methods for coating a substrate or for sealing together two substrates.

The process of free-radical polymerisation of ethylenically unsaturated compounds has the advantages of low energy demand, rapid and readily controllable reaction kinetics, excellent mechanical properties and the versatility available with a broad array of monomers. A conventional way of curing unsaturated polymerizable compositions by free-radical photopolymerisation is the combined utilization of the polymerizable monomer and a photoinitiating system. Initiation by UV irradiation has been widely used, but has certain drawbacks, in particular the requirement of stringent safety regulations to protect the operational personnel from skin burning and eye hurting (keratitis photoelectrica). Further it has been known that free-radical polymerization of ethylenically α,β-unsaturated compounds can be initiated by exposure to visible light. Photoinitiating systems which are capable of curing by visible light conventionally involve the use of photoreducible dyes, various co-catalysts and accelerator compounds. For instance, EP 0097012 B2 describes derivatives of acetophenone, which have been used as photosensitizers in combination with Eosin dyes and tertiary amines as reducing agent. The tertiary amines reduce the dye only when in the excited state and thus form starter radicals.

DE 3832032 A1 describes a photopolymerizable composition comprising a polymerizable compound, a photoreducible dye, e.g. Eosin, metallocenes as co-catalysts and trihalogenmethyl compounds. The trihalogenmethyl compounds are cleavable by radiation, which are used to increase the visible radiation sensitivity.

In order to enable tack-free surface cure under exposure to visible light, WO 2006/083343 A1 suggests a combination of a dye with a tertiary amine and a trihalogenmethyl compound.

Similar photocurable systems are described in EP 0924569 A1, WO 2010/003026 A1, EP 0684522 B2, WO 91/16360 A1 and US 2009/0259166 A1.

The use of α-halogen carbonyl compounds, more specifically of diacylhalomethane compounds, is described in U.S. Pat. No. 3,615,455.

Despite intensive investigations towards curing of photocurable compositions, the application of visible light under oxygen-containing atmosphere has resulted only in sticky surfaces. Generally a large amount of dye is required, which leads to colored coatings. Tack-free curing of photocurable compositions in oxygen-containing atmosphere, combined with large layer thicknesses is only possible with UV-light.

Thus, it is an object of this invention to provide photocurable coating compositions which can be cured by visible light and which can be applied to prepare tack-free, colorless coatings under oxygen-containing atmosphere for technical utilizations in flooring, coating, sealant and adhesive industries. Further only a small amount of co-reactants should be required in order to extend the possible layer thicknesses of the photocurable compositions.

This object is achieved by a photocurable composition that is curable by exposure to visible light, comprising a free-radical polymerizable compound and a photoinitiating system, the photoinitiating system comprising

a) a dye which is excitable by visible light and has a triplet energy from 150 kJ/mol to 250 kJ/mol, and

b) an α-halogen carbonyl compound.

In certain embodiments, the photoinitiating system additionally contains a compound with a C—H-acidic hydrogen atom adjacent to at least one carbonyl group (also referred to as C—H acidic compound). The addition of a C—H acidic compound enables the amount of α-halogen carbonyl compound to be reduced since C—H acidic compounds readily form anions which can react with the photo initiators to form further initiating radicals. Furthermore, addition of a C—H acidic compound allows the preparation of coatings which are colorless after completion of the curing.

The present invention provides photocurable compositions, e.g. photocurable coating compositions, containing a mono- or polyunsaturated monomer or mixtures thereof, and a photoinitiating system comprising a dye, like Eosin Y, an α-halogen carbonyl compound and, optionally, a C—H acidic compound. The photocurable compositions are capable of being cured upon exposure to visible light under oxygen-containing atmosphere to impart tack-free, colorless surface cure.

The present intervention will now be described in detail.

“Visible light” is intended to mean electromagnetic irradiation with a single wavelength in the range from 400 nm to 800 nm, or electromagnetic irradiation with a plurality of wavelengths with a wavelength distribution such that at least 90% of the electromagnetic energy is from radiation in the range from 400 nm to 800 nm. Preferably, the light used for curing the photocurable composition includes radiation with wavelength(s) in the range of from 440 nm to 600 nm. In some embodiments the light source used is a VIS-LED with a narrow emission window to inhibit side reactions. Furthermore VIS-LEDs are cool light sources facilitating curing of photocurable compositions containing volatile organic compounds. The preferred light sources are emitting light at about 535 nm (green light LED) or about 470 nm (blue light LED).

The free-radical polymerizable ethylenically α,β-unsaturated compounds (herein also referred to as “polymerizable compounds”) include compounds having at least one ethylenically unsaturated functionality. The polymerizable compounds may be used individually or as combination of two or more compounds.

In preferred embodiments, the polymerizable compound comprises at least one polyethylenically unsaturated compound. A polyethylenically unsaturated compound contains two or more ethylenically unsaturated functionalities per molecule.

Examples of the polymerizable compounds include C₁-C₂₀-alkyl(meth)acrylates, C₁-C₂₀-hydroxyalkyl(meth)acrylates, polyol poly(meth)acrylates, heterocycloalkylalkyl (meth)acrylates, cycloalkyl(methyl)acrylates, cycloalkylalkyl(meth)acrylates and amine-modified polyetheracrylates.

The term “alkyl” preferably means C₁-C₂₀ alkyl and includes, for example, methyl, ethyl, propyl, isopropyl, n-butyl, isobutyl, sec.-butyl, tert.-butyl, n-pentyl, 2-pentyl, 2-methylbutyl, 3-methylbutyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethyl pentyl, 1-propylbutyl, n-octyl, 2-ethylhexyl, 2-propylheptyl, 1,1,3,3-tetramethylbutyl, nonyl, decyl, n-undecyl, n-dodecyl, n-tridecyl, isotridecyl, n-tetradecyl, n-hexadecyl, n-octadecyl, n-eicosyl, etc.

The term “alkoxy” means an alkyl group as defined above, linked to the remainder of the molecule via an oxygen atom.

The term “acyl” means an alkyl group as defined above, linked to the remainder of the molecule via a carbonyl group.

The term “aryl” means a aromatic hydrocarbon with 5 to 7 ring carbon atoms or a polycyclic aromatic hydrocarbon, which includes, for example, phenyl, tolyl, xylyl, thienyl, naphthyl, etc.

The term “cycloalkyl” means a saturated cyclic hydrocarbon with 3 to 7 ring carbon atoms, which includes, for example, cyclopropyl, cyclobutyl, cyclopentyl, cyclohexyl and cycloheptyl, etc. The cycloalkyl moiety may be substituted by one to three C₁-C₄ alkyl substituents.

The term “heterocycloalkyl” means a saturated heterocycle with 4 to 7 ring atoms, which includes, for example, tetrahydrofurfuryl, dioxane, etc. The heterocycloalkyl moiety may be substituted by one to three C₁-C₄ alkyl substituents.

The term “polyol” is intended to mean a hydrocarbon molecule with at least two hydroxy groups, for example two to five hydroxyl groups, which includes, for example, ethylenglycole, glycerine, trimethylol propane, pentaerytrithol, dipenta-erytrithol, diethylenglycole, poly(propylenglycole), etc.

The term “polyether” is intended to mean compounds having more than one ether linkages, in particular polymers having ether linkages in their main chain. Examples of suitable polyethers are those which can be obtained by known processes, by reacting dihydric and/or polyhydric alcohols, for example the abovementioned diols or polyols, with various amounts of ethylene oxide and/or propylene oxide. Polymerization products of tetrahydrofuran or of butylene oxide may also be used. Preferred polyethers are polyethylene glycols, e.g. polyethylene glycols having a weight averaged molecular weight of 200 to 9 500.

The term “amine-modified polyether(meth)acrylate” is intented to denote a polyether (meth)acrylate ester containing at least one amino group in the molecule. Such compounds are obtainable by reacting a polyether(meth)acrylate with primary or secondary amino compounds, so that at least some of the (meth)acrylate groups, e.g. 0.5 to 60 mol % of the (meth)acrylate groups, undergo a Michael reaction with the amino compounds to form Michael adducts. Suitable compounds having primary or secondary amino groups are in general low molecular weight and preferably have a molecular weight of less than 1000. Preferred compounds contain from 1 or 2 to 6, particularly preferably from 2 to 4, amine hydrogen atoms (N—H) of primary or secondary amines. Examples are primary monoamines (2 amine hydrogen atoms), such as C₁-C₂₀-alkylamines, in particular n-butylamine, n-hexylamine, 2-ethylhexylamine or octadecylamine, cycloaliphatic amines, such as cyclohexylamine, and amines containing (hetero)aromatic groups, such as benzylamine, 1-(3-aminopropyl)imidazole or tetrahydrofurfurylamine. Compounds having 2 primary amino groups are, for example, C₁-C₂₀ alkylenediamines, such as ethylenediamine, butylenediamine, etc. Amino compounds having at least 1 hydroxyl group, preferably from 1 to 3 hydroxyl groups, particularly preferably 1 hydroxyl group, are also particularly suitable. Examples are alkanolamines, in particular C₂-C₂₀ alkanolamines, such as ethanolamine, propanolamine or butanolamine. The Michael adducts can be formed in a simple manner by adding the amino compounds to the (meth)acrylates at, preferably, from 10° to 100° C.

Specific examples of the polymerizable compounds are 2-hydroxyethyl methacrylate, dipentaerytrithol pentaacrylate, tetrahydrofurfuryl acrylate, tetrahydrofurfuryl methacrylate, trimethylolpropane triacrylate, trimethylolpropane trimethylacrylate, poly(propyleneglycole) dimethacrylate, trimethylolpropaneformal monoacrylate (Laromer LR 8887 commercially available from BASF SE, Ludwigshafen Germany), 2-[[[4-[bis[2-(2-methylprop-2-enoyloxy)ethoxymethyl]amino]-6-[bis(4-prop-2-enoyloxybutoxymethyl)amino]-1,3,5-triazin-2-yl]-(4-prop-2-enoyloxybutoxymethyl)amino]methoxy]-ethyl 2-methylprop-2-enoate (Laromer LR 9054 commercially available from BASF SE, Ludwigshafen Germany) pentaerythritol tetraacrylate, diethylenglycole dimethacrylate and an amine modified polyether acrylate (CN UVA 421 commercially available from Sartomer Europe, Colombes Cedex France).

The dye comprised by the photoinitiating system of the invention is excitable by visible light. Thus, it absorbs electromagnetic irradiation in the visible range, i.e. about 400 nm to 800 nm wavelength. Useful dyes are fluorescing dyes with a maximum absorption wavelength from 450 nm to 550 nm.

The dye absorbs light at one wavelength and emits it at a longer wavelength. The dye is preferably a fluorescing dye. The dye is one that is photoreducible by the co-catalyst, namely an α-halogen carbonyl compound, only when it is raised to an excited state by exposure to visible light, preferably, by exposure to sunlight or light of a green or blue light emitting LED. The dye functions as a photosensitizer for the co-catalyst and therefore requires suitable triplet energies in the range of from 150 kJ/mol to 250 kJ/mol. An similar mechanism by electron transfer from donors such as aromatic amino acids or aliphatic amines to the triplet state of methylene blue and xanthene dyes in air-saturated aqueous solution has been proposed by Goerner, H. in Photochemical & Photobiological Sciences (2008), 7(3), 371-376).

“Triplet energy” is intended to mean the energy level of the triplet state, which a molecule can reach by excitation from the ground state to its singulet state and subsequent intersystem crossing, forming the triplet state with an unpaired spin orientation. Intersystem crossing is a radiationless process involving a transition between two electronic states (here singulet and triplet) with different spin multiplicity. The triplet state is relatively persistent compared to the singulet state and enables the molecule to act as a photosensitizer, transferring its energy to a second molecule. Triplet energies of many dyes are listed in standard text books, such as the Handbook of Photochemistry, published by Marcel Dekker, New York, the book Environmental Toxicology and Chemistry of Oxygen Species, published by Springer, Berlin, and the CRC Handbook of Organic Photochemistry and Photobiology, published by Taylor & Francis Group, Boca Raton.

Preferably, the dye is a xanthen dye of the formula I below in which R¹ represents H, Br or I and M represents H, K, Na, Li or NH₄.

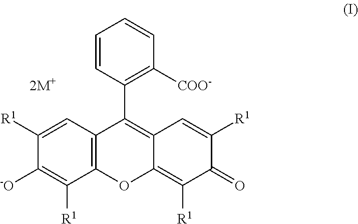

Particularly preferred dyes are Eosin Yellow (having a maximum absorption wavelength of 540 nm and a triplet energy of 177 kJ/mol) or Fluorescein (having a maximum absorption wavelength of 484 nm and a triplet energy of 190-200 kJ/mol).

Suitably, the photoinitiating system contains form 0.005% to 0.50% by weight, e.g. 0.008% to 0.40 by weight, preferably from 0.05% to 0.20% by weight, of dye, based on the total amount of polymerizable compound. The amounts of each component of the photoinitiating system are based on the total amount of polymerizable compound by weight. Generally, lower amounts are insufficient to compensate the fast terminating reaction of free radicals with oxygen. Higher amounts are disadvantageous from a cost point of view and can result in unwanted discoloration.

In the photoinitiating system of the invention, an α-halogen carbonyl compound is used as a co-catalyst. Preferably, the halogen represents a Cl, Br or I atom, in particular a Br atom. The co-catalyst serves to reduce the dye when the dye is in an excited state but should be inert to the dye during storage and when it is not excited by exposure to visible light. The co-catalyst is believed to reduce the excited dye by an electron transfer from the excited dye in the triplet state to the α-halogen carbonyl compound under radical generation, initiating the free-radical polymerisation reaction.

Preferably the α-halogen carbonyl is a compound of formula IIa or IIb

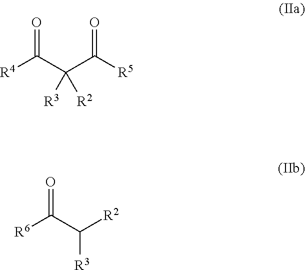

wherein:
R² represents a halogen atom, preferably Cl, Br or I, in particular Br,
R³ represents a halogen atom or a hydrogen atom,
R⁴, R⁵ independently represent aryl, C₁-C₂₀-alkoxy, C₁-C₂₀-alkyl, or
R⁴ and R⁵ together with the carbon atom to which they are attached and the intervening carbon atoms form a 5 to 7 membered cyclic structure which may contain 1 or 2 heteroatoms and/or a carbonyl group, wherein the 5 to 7 membered cyclic structure can be substituted by one to three substituents selected from C₁-C₄-alkyl, C₁-C₄-alkoxy or aryl substituents, and/or may be annelated by a saturated or unsaturated cycle, and
R⁶ represents (4-halogen)-phenyl, or (2-halogen)-acyl.

Specific examples of the α-halogen carbonyl compound are 5,5′-dibromomeldrum's acid, 2-bromo-1,3-indandione, diethylbromomalonate, 2-bromo-1,3-diphenyl-propane-1,3-dione, 2,2,4′-tribromoacetophenon and 1,4-dibromo-2,3-butandione.

The photoinitiating system contains from 0.2% to 4% by weight, preferably form 1% to 2% by weight α-halogen carbonyl compound, based on the total amount of polymerizable compound.

In preferred embodiments of the invention, a compound with a C—H-acidic hydrogen atom adjacent to at least one carbonyl group (herein also referred to as “C—H-acidic compound”), is included in the photoinitiating system. Incorporation of the C—H acidic compounds enables colorless curing which means that the fully cured composition appears colorless. Although the mechanism of the triggered colorless curing in the presence of the C—H-acidic compound is not fully understood it is believed that the C—H-acidic compound serves to convert the dye in a leuko form thereof.

The C—H-acidic compound is generally a α-hydrogen carbonyl compound, preferably a compound of formula III

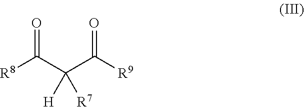

wherein:
R⁷ represents a hydrogen atom or a C₁-C₄-alkyl group,
R⁸, R⁹ independently represent a hydrogen atom, C₁-C₂₀-alkyl or C₁-C₂₀-alkoxy, or R⁸ and R⁹ together with the carbon atoms to which they are attached and the intervening carbon atom form a 5 to 7 membered cyclic structure which may contain 1 or 2 heteroatoms and/or a carbonyl group, wherein the 5 to 7 membered cyclic structure can be substituted by one to three substituents selected from C₁-C₄-alkyl, C₁-C₄-alkoxy or aryl and/or may be annelated by a saturated or unsaturated cycle.

Specific examples of the C—H-acidic compound are methyl meldrum's acid, 1,3-dimethylbarbituric acid and 2,2-dimethyl-1,3-dioxane-4,6-dione.

If a C—H-acidic compound is used, it is generally included in the photoinitiating system in an amount from 0.5% to 5% by weight, preferably from 2% to 5% by weight, based on the total amount of polymerizable compound.

In certain embodiments, a filler is included in the photocurable composition. Examples of fillers are calcium carbonate, barium sulfate, titanium oxides, silicates, quartz powder, glass beads, carbon black, or graphite.

The photocurable composition may contain from 0.4% to 100% by weight of filler, based on the total amount of polymerizable compound.

In addition, the photocurable composition may contain slip additives, defoamers, emulsifiers, wetting agents, adhesion promoters, leveling agents, coalescing agents, rheology control additives such as polymers or copolymers of methyl methacrylate, n-butyl methacrylate, isobutyl methacrylate and/or isodecyl methacrylate, and flame retardants.

Solvents may be included in the photocurable composition. Preferred solvents are alcohols such as methanol, ethanol, iso-propanol, tert-butanole; esters such as ethylacetate; ketones such as acetone; halogenated hydrocarbons such as dichlormethane, trichlormethane and the like.

The photocurable composition is mixed prior to use, applied to the substrate in its desired final shape and the curing is caused by exposing to visible light. The photocurable composition provides a step-wise curing profile and therefore a practicable workability. The curing is possible at low temperatures, down to −30° C., e.g. 0 to 45° C. Curing can be carried out in an oxygen-containing atmosphere, e.g. ambient atmosphere with about 20% oxygen concentration. The curing is also possible in an atmosphere with lower oxygen concentration such as reduced oxygen air, or in the absence of oxygen.

Thus, a further aspect of the present intervention relates a method for coating a substrate, the method comprises applying a photocurable composition to the substrate and exposing the photocurable composition to visible light. The substrate may be a cementeous surface, glass, metal, wood or polymer compounds. The photocurable composition may be applied to the surface by brushing, spraying, spinning or scraping. It is possible to apply a solution of the above ingredients in an organic solvent onto a substrate, followed by volatilization of the organic solvent.

Another aspect of the present invention is a method for sealing together two substrates, where at least one of the two substrates is transparent. The substrates preferably have essentially flat surfaces. The composition is applied on one substrate, the second substrate is mated together to form an assembly and the assembly is then exposed to visible light. The glass surfaces, which were glued together, showed no changes in transparency or colorlessness under irradiation with sunlight over extended periods. Thus, this embodiment of the invention may preferably used as adhesive for glass assemblies.

For example, the photocurable composition of the present invention can be used as a sealing material for the preparation of liquid crystal panels or organic electroluminescence (EL) devices.

The liquid crystal panel can be prepared, for example, in the following manner. The photocurable composition is applied to one of front and back substrates having, for example, thin-film transistors, display electrodes, alignment layer, color filters and/or an electrode. Then, the other paired substrate is overlaid thereon after adjusting a position. The photocurable composition is cured by applying radiation from the surface or side of the substrate. A liquid crystal is then charged into the resulting liquid crystal cell through a filling port, and the filling port is sealed with an end-sealing material to obtain the liquid crystal panel.

The liquid crystal panel can also be prepared in the following manner. The photocurable composition is applied in the form of a frame to the outer periphery of one of the two substrates, and the liquid crystal is added dropwise into the frame. The other paired substrate is overlaid thereon in vacuum, and the photocurable composition is cured by applying radiation.

The photocurable composition for sealing a liquid crystal panel of the present invention may be applied to the surface of the substrate with the use of a dispenser or by screen printing.

In the manufacture of an EL device, an organic EL layer comprising a transparent electrode, a hole transporting layer, an organic EL layer and a back electrode is formed on a glass or film substrate, then the photocurable composition is applied onto the organic EL layer, and the organic EL layer and a water-impermeable glass or film substrate are laminated together. The photocurable composition is cured by applying radiation from the surface or side of the substrate.

The invention is now further illustrated by the examples which follow.

General Procedure:

Where not stated otherwise, the experiments have been investigated in the following procedure: (Meth)acrylic monomers, co-reactants and from top (above) for several minutes. Afterwards, the coatings/layers have been checked by hand for tack-freedom. Minimum layer thicknesses have been cured around 100 μm, maximum layer thicknesses have been 3 cm.

### EXAMPLE 1

According to the general procedure above, 5 mL 2-hydroxyethyl methacrylate, 25 mg 2-bromo-1,3-diphenyl-propane-1,3-dione, 25 mg 1,3-dimethylbarbituric acid and 250 μL Eosin Yellow disodium salt (0.05 M in MeOH) were mixed and irradiated for 10-30 minutes via an green light emitting LED. Afterwards, the coating was yellow, transparent and tack-free.

### EXAMPLE 2

According to the general procedure above, 1 mL amine modified polyether acrylate (CN UVA 421), 20 μL diethylbromo malonate and 50 μL Fluorescein disodium salt (0.05 M in MeOH) were mixed and irradiated for 10-30 minutes via a blue light emitting LED. Afterwards, the coating was slightly yellow, transparent and tack-free.

### EXAMPLE 3

According to the general procedure above, 5 mL tetrahydrofurfuryl methacrylate, 20 mg 5,5′-dibromomeldrum's acid, and 50 μL Eosin Yellow disodium salt (0.05 M in MeOH) were mixed and irradiated for 10-30 minutes via an green light emitting LED. Afterwards, the coating was yellow, transparent and tack-free.

### EXAMPLE 4

According to the general procedure above, 5 mL 2-hydroxyethyl methacrylate methacrylate, 10 mg 2-bromo-1,3-indandione, and 250 μL Fluorescein disodium salt (0.05 M in MeOH) were mixed and irradiated for 10-30 minutes via a blue light emitting LED. Afterwards, the coating was light yellow, transparent and tack-free.

### EXAMPLE 5

According to the general procedure above, 5 mL 2-hydroxyethyl methacrylate, 20 mg 5,5′-dibromomeldrum's acid, and 50 μL Eosin Yellow disodium salt (0.05 M in MeOH) were mixed and irradiated for 10-30 minutes via an green light emitting LED. Afterwards, the coating was yellow, transparent and tack-free.

### EXAMPLE 6

According to the general procedure above, 5 mL 2-hydroxyethyl methacrylate, 125 μL 1,4-dibromo-2,3-butandione, 260 mg 1,3-dimethylbarbituric acid and 250 μL Fluorescein disodium salt (0.05 M in MeOH) were mixed and irradiated for 10-30 minutes via a blue light emitting LED. Afterwards, the coating was light yellow, transparent and tack-free.

### EXAMPLE 7

According to the general procedure above, 5 mL pentaerythritol pentaacrylate, 20 mg 5,5′-dibromomeldrum's acid, and 50 μL Eosin Yellow disodium salt (0.05 M in MeOH) were mixed and irradiated for 10-30 minutes via an green light emitting LED. Afterwards, the coating was yellow, transparent tack-free.

### EXAMPLE 8

According to the general procedure above, 5 mL 2-hydroxyethyl methacrylate, 90 μL diethyl bromomalonate, 100 mg 1,3-dimethylbarbituric acid and 250 μL Eosin Yellow disodium salt (0.05 M in MeOH) were mixed and irradiated for 10-30 minutes via an green light emitting LED. Afterwards, the coating was yellow, transparent tack-free.

### EXAMPLE 9

According to the general procedure above, 5 mL 2-hydroxyethyl methacrylate, 90 μL diethyl bromomalonate, 100 mg 1,3-dimethylbarbituric acid and 250 μL Fluorescein disodium salt (0.05 M in MeOH) were mixed and irradiated for 10-30 minutes via a blue light emitting LED. Afterwards, the coating was yellow, transparent tack-free.

### EXAMPLE 10

According to the general procedure above, 5 mL 2-hydroxyethyl methacrylate, 60 μL 1,4-dibromo-2,3-butandione, 100 mg 1,3-dimethylbarbituric acid and 250 μL Fluorescein disodium salt (0.05 M in MeOH) were mixed and irradiated for 10-30 minutes via a blue light emitting LED. Afterwards, the coating was yellow, transparent tack-free.

### EXAMPLE 11

According to the general procedure above, 5 mL 2-hydroxyethyl methacrylate, 25 mg 2-bromo-1,3-indandione, 65 mg 2,2-dimethyl-1,3-dioxane-4,6-dione and 250 μL Fluorescein disodium salt (0.05 M in MeOH) were mixed and irradiated for 10-30 minutes via a blue light emitting LED. Afterwards, the coating was yellow, transparent tack-free.

### EXAMPLE 12

According to the general procedure above, 5 mL ON UVA 421, 10 mg 2,2,4′-tribromoacetophenone and 50 μL Eosin Yellow disodium salt (0.05 M in MeOH) were mixed and irradiated for 10-30 minutes via a green light emitting LED. Afterwards, the coating was yellow, transparent tack-free.

### EXAMPLE 13

According to the general procedure above, 5 mL 2-hydroxyethyl methacrylate, 100 mg 5,5′-dibromomeldrum's acid, 50 mg 1,3-dimethylbarbituric acid and 10 μL Eosin Yellow disodium salt (0.05 M in MeOH) were mixed and irradiated for 10-30 minutes via a green light emitting LED. Afterwards, the coating was colorless, transparent tack-free.

### EXAMPLE 14

According to the general procedure above, 10 mL 2-hydroxyethyl methacrylate, 200 mg 5,5′-dibromomeldrum's acid, 260 mg 1,3-dimethylbarbituric acid, 25 g SIKRON 3000, 18 mg BYK-UV-3500 and 500 μL Eosin Yellow disodium salt (0.05 M in MeOH) were mixed and irradiated for 30 minutes via a green light emitting LED. Afterwards, the coating was yellow and tack-free.

### EXAMPLE 15

According to the general procedure above, a mixture of 0.5 mL 2-hydroxyethyl methacrylate, 7 mL pentaerythritol tetraacrylate, 2.5 mL pentaerythritol pentaacrylate and 200 mg 5,5′-dibromomeldrum's acid, 260 mg 1,3-dimethylbarbituric acid, 5 g SIKRON 3000, 18 mg BYK-UV-3500, and 500 μL Eosin Yellow disodium salt (0.05 M in MeOH) were mixed and irradiated for 30 minutes via a green light emitting LED. Afterwards, the coating was yellow and tack-free.

### EXAMPLE 16

According to the general procedure above, a mixture of 10 mL 2-hydroxyethyl methacrylate, 200 mg 5,5′-dibromomeldrum's acid, 260 mg 1,3-dimethylbarbituric acid, 0.5-2.5 g CRENOX CR-435, 18 mg BYK-UV-3500, and 500 μL Eosin Yellow disodium salt (0.05 M in MeOH) were mixed and irradiated for 30 minutes via a green light emitting LED. Afterwards, the coating was yellow and tack-free.

### EXAMPLE 17

According to the general procedure above, a mixture of 0.25 mL 2-hydroxyethyl methacrylate, 3.5 mL pentaerythritol tetraacrylate, 1.25 mL pentaerythritol pentaacrylate and 200 mg 5,5′-dibromomeldrum's acid, 260 mg 1,3-dimethylbarbituric acid, 5 g SIKRON 3000, 18 mg BYK-UV-3500 and 500 μL Eosin Yellow disodium salt (0.05 M in MeOH) were mixed, applied on a cementeous surface (15×7.5 cm) and irradiated for 30 minutes via a green light emitting LED. Afterwards, the coating was yellow and tack-free.

### EXAMPLE 18

According to the general procedure above, 5 mL 2-hydroxyethyl methacrylate, 500 mg poly(BMA-co-iBMA), 100 mg 5,5′-dibromomeldrum's acid, 260 mg 1,3-dimethylbarbituric acid and 200 μL Eosin Yellow disodium salt (0.05 M in MeOH) were mixed, applied on a cementeous surface (15×7.5 cm) and irradiated for 30 minutes via a green light emitting LED. Afterwards, the coating was yellow and tack-free.

### EXAMPLE 19

According to the general procedure above, 0.25 mL 2-hydroxyethyl methacrylate and 4.75 mL tetrahydrofurfuryl methacrylate, 100 mg 5,5′-dibromomeldrum's acid, 260 mg 1,3-dimethylbarbituric acid, 100 μL Eosin Yellow disodium salt (0.05 M in MeOH) were mixed and applied on a glass surface (10×10 cm). Another untreated glass surface was put on the coated surface and the glasses irradiated for 30 minutes via a green light emitting LED. Afterwards, the coating was transparent and the glasses couldn't be removed by hand. The glued glass was put in a Q-Sun machine (Xenon-Light with Daylight-Filter 0.68 W/m², BlackPanel-Temp. 67° C. surface, air-temperature 40° C., humidity 50% r.H) and monitored for 14 days (UV-VIS-measurements). The VIS-region of the spectra (>360 nm) showed no changes, the glasses glued together and could not be detached from each other and showed transparency and colorlessness.

### EXAMPLE 20

According to the general procedure above, 0.25 mL 2-hydroxyethyl methacrylate, 4.75 mL pentaerythritol tetraacrylate, 100 mg 5,5′-dibromomeldrum's acid, 260 mg 1,3-dimethylbarbituric acid, 100 μL Eosin Yellow disodium salt (0.05 M in MeOH) were mixed and applied on a glass surface (10×10 cm). Another untreated glass surface was put on the coated surface and the glasses irradiated for 30 minutes via a green light emitting LED. Afterwards, the coating was transparent and the glasses couldn't be removed by hand. The glued glass was put in a Q-Sun machine (Xenon-Light with Daylight-Filter 0.68 W/m², BlackPanel-Temp. 67° C. surface, air-temperature 40° C., humidity 50% r.H) and monitored for 14 days (UV-VIS-measurements). The VIS-region of the spectra (>360 nm) showed no changes, the glasses glued together and could not be detached from each other and showed transparency and colorlessness.

### EXAMPLE 21

According to the general procedure above, 0.25 mL 2-hydroxyethyl methacrylate, 4.75 mL Trimethylolpropane trimethacrylate, 100 mg 5,5′-dibromomeldrum's acid, 260 mg 1,3-dimethylbarbituric acid, 100 μL Eosin Yellow disodium salt (0.05 M in MeOH) were mixed and applied on a glass surface (10×10 cm). Another untreated glass surface was put on the coated surface and the glasses irradiated for 30 minutes via a green light emitting LED. Afterwards, the coating was transparent and the glasses couldn't remove by hand. The glued glass was put in a Q-Sun machine (Xenon-Light with Daylight-Filter 0.68 W/m², BlackPanel-Temp. 67° C. surface, air-temperature 40° C., humidity 50% r.H) and monitored for 14 days (UV-VIS-measurements). The VIS-region of the spectra (>360 nm) showed no changes, the glasses glued together and could not be detached from each other and showed transparency and colorlessness.

### EXAMPLE 22

According to the general procedure above, 0.25 mL 2-Hydroxyethyl methacrylate, 4.75 mL Diethylenglycole dimethacrylate, 100 mg 5,5′-Dibromomeldrum's acid, 260 mg 1,3-Dimethylbarbituric acid, 100 μL Eosin Yellow disodium salt (0.05M in MeOH) were mixed and applied on a glass surface (10×10 cm). Another untreated glass surface was put on the coated surface and the glasses irradiated for 30 minutes via a green light emitting LED. Afterwards, the coating was transparent and the glasses couldn't remove by hand. The glued glass was put in a Q-Sun machine (Xenon-Light with Daylight-Filter 0.68 W/m², BlackPanel-Temp. 67° C. surface, air-temperature 40° C., humidity 50% r.H) and monitored for 14 days (UV-VIS-measurements). The VIS-region of the spectra (>360 nm) showed no changes, the glasses glued together and could not be detached from each other and showed transparency and colorlessness.

1: A photocurable composition, comprising:
a free-radical polymerizable compound, and
a photoinitiating system, the photoinitiating system comprising:
a) a dye which is excitable by visible light and has a triplet energy form 150 kJ/mol to 250 kJ/mol, and
b) an α-halogen carbonyl compound,
wherein the photocurable composition is curable by exposure to visible light.

2: The photocurable composition according to claim 1, in which dye a) comprises a xanthen dye.

3: The photocurable composition according to claim 2, in which dye a) is at least one member selected from the group consisting of Eosin Yellow and Fluorescein.

4: The photocurable composition according to claim 1, in which the α-halogen carbonyl compound b) is a compound represented by formula IIa or IIb: 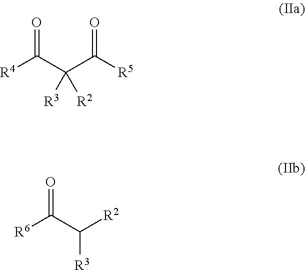
wherein:
R² represents a halogen atom,
R³ represents a halogen atom or a hydrogen atom,
R⁴, R⁵ independently represent aryl, C₁-C₂₀-alkoxy, C₁-C₂₀-alkyl, or
R⁴ and R⁵ together with the carbon atom to which they are attached and the intervening carbon atoms form a 5 to 7 membered cyclic structure which may have 1 or 2 heteroatoms and/or a carbonyl group, wherein the 5 to 7 membered cyclic structure can be substituted by one to three substituents selected from C₁-C₄-alkyl, C₁-C₄-alkoxy or aryl substituents, and/or may be annelated by a saturated or unsaturated cycle, and
R⁶ represents (4-halogen)-phenyl or (2-halogen)-acyl.

5: The photocurable composition according to claim 4, in which the α-halogen carbonyl compound b) is at least one member selected from the group consisting of
5,5′-dibromomeldrum's acid; 2-bromo-1,3-indandione; diethylbromomalonate; 2-bromo-1,3-diphenyl-prop-ane-1,3-dione; 2,2,4′-tribromoacetophenon; and 1,4-dibromo-2,3-butandione.

6: The photocurable composition according to claim 1, in which the free-radical polymerizable compound is an α,β-ethylenically unsaturated compound.

7: The photocurable composition according to claim 6, in which the free-radical polymerizable compound comprises a polyethylenically unsaturated compound.

8: The photocurable composition according to claim 6, in which the free-radical polymerizable compound is at least one member selected from the group consisting of
a C₁-C₂₀-alkyl(meth)acrylate; a C₁-C₂₀-hydroxyalkyl(meth)acrylate; a polyol poly(meth)acrylate; a heterocycloalkylalkyl(meth)acrylate; a cycloalkyl(methyl)acrylate; a cycloalkylalkyl(meth)acrylate; and an amine modified polyetheracrylate.

9: The photocurable composition according to claim 8, in which the free-radical polymerizable compound is at least one member selected from the group consisting of
2-hydroxyethyl methacrylate; dipentaerytrithol pentaacrylate; tetrahydrofurfuryl acrylate; tetrahydrofurfuryl methacrylate; trimethylolpropane triacrylate; trimethylolpropane trimethylacrylate; poly(propyleneglycole) dimethacrylate; trimethylolpropaneformal monoacrylate; Laromer 9054; pentaerythritol tetraacrylate; and diethylenglycole dimethacrylate.

10: The photocurable composition according to claim 1, which additionally comprises a compound with a C—H-acidic hydrogen atom adjacent to at least one carbonyl group.

11: The photocurable composition according to claim 10, in which the compound with a C—H-acidic hydrogen atom adjacent to at least one carbonyl group is at least one member selected from the group consisting of
methyl meldrum's acid; 1,3-dimethylbarbituric acid; and 2,2-dimethyl-1,3-dioxane-4,6-dione.

12: The photocurable composition according to claim 1, which further comprises a filler.

13: The photocurable composition according to claim 12, in which the filler is at least one member selected from the group consisting of barium sulfate; titanium oxide; a silicone; a polymers; and a copolymer.

14: A method for coating a substrate, the method comprising:
a) applying to the substrate a photocurable composition according to claim 1, and
b) curing exposing the photocurable composition with visible light.

15: A method for sealing together two substrates, the method comprising:
a) applying a photocurable composition according to claim 1 to at least one of the two substrates.
b) mating the substrates together to form an assembly, and
c) curing the photocurable composition within the assembly with visible light,
wherein one of the two substrates is transparent.

16: The method according to claim 14, wherein
the curing is carried out in an atmosphere that comprises oxygen.

17: The method according to claim 15, wherein
the curing is carried out in an atmosphere that comprises oxygen.

18: The photocurable composition according to claim 4, wherein
R² represents Cl, Br, or I.
